(19) United States
(12) Patent Application Publication
(10) Pub. No.: US 2025/0379219 A1
(43) Pub. Date: Dec. 11, 2025

(54) NEGATIVE ACTIVE MATERIAL, METHOD OF PREPARING SAME, AND RECHARGEABLE LITHIUM BATTERY INCLUDING SAME

(71) Applicants: SAMSUNG SDI CO., LTD., Yongin-si (KR); UNIVERSITY-INDUSTRY COOPERATION GROUP OF KYUNG HEE UNIVERSITY, Yongin-si (KR)

(72) Inventors: Ilyoung CHOI, Yongin-si (KR); Narae KIM, Yongin-si (KR); Deok-Hyun KIM, Yongin-si (KR); Youngugk KIM, Yongin-si (KR); Min-Sik PARK, Yongin-si (KR); Joo Hyeong SUH, Yongin-si (KR); Won Ung JUNG, Yongin-si (KR); Dong Ki KIM, Yongin-si (KR)

(21) Appl. No.: 19/226,031

(22) Filed: Jun. 2, 2025

(30) Foreign Application Priority Data
Jun. 10, 2024 (KR) 10-2024-0075106

(51) Int. Cl. H01M 4/36; C01B 32/21; H01M 4/587; H01M 10/052

(52) U.S. Cl. CPC H01M 4/366; C01B 32/21; H01M 4/587; H01M 10/052; C01P 2002/72; C01P 2004/04; C01P 2004/80; C01P 2006/40

(57) ABSTRACT

Disclosed are a negative active material, a method of preparing the same, and a rechargeable lithium battery including the same. The negative active material includes a core including a carbonaceous material; and a metal-including nitride on a surface of the core and having lower lithium adsorption energy and lower lithium ion diffusion energy than the core.

### CROSS-REFERENCE TO RELATED APPLICATION

The present application claims priority to and the benefit of Korean Patent Application No. 10-2024-0075106, on Jun. 10, 2024, filed in the Korean Intellectual Property Office, the entire content of which is hereby incorporated by reference.

### BACKGROUND

### 1. Field

Embodiments of the present disclosure relate to a negative active material, a method of preparing same, and a rechargeable lithium battery including the same.

### 2. Description of the Related Art

Recently, with the rapid spread of electronic devices that use batteries, e.g., mobile phones, laptop computers, and electric vehicles, a demand for smaller, lighter and relatively high-capacity rechargeable lithium batteries is rapidly increasing. Improving performance of rechargeable lithium batteries has been considered.

Rechargeable lithium batteries include a positive electrode and a negative electrode including an active material capable of intercalating and deintercalating lithium ions, and an electrolyte solution, and electrical energy is produced by oxidation and reduction reactions when lithium ions are intercalated/deintercalated at the positive and negative electrodes.

### SUMMARY

One or more embodiments of the present disclosure provide a negative active material exhibiting high initial efficiency, long cycle-life characteristic, and excellent fast chargeability.

Another embodiment provides a method of preparing the negative active material.

Still another embodiment provides a rechargeable lithium battery including the negative active material.

One or more embodiments provide a negative active material including a core including a carbonaceous material; and a metal-including nitride on a surface of the core and having lower lithium adsorption energy and lower lithium ion diffusion energy than the core.

Another embodiment provides a method of preparing a negative active material, the method including coating crystalline carbon with a metal compound liquid to prepare a primary coating material; primary heat-treating the primary coating material to prepare a primary heat-treated product; preparing a mixture including the primary heat-treated product and a magnesium powder; secondary heat-treating the mixture under a nitrogen atmosphere to prepare a secondary heat-treated product; and etching the secondary heat-treated product.

Still another embodiment provides a rechargeable lithium battery including a negative electrode including the negative active material; a positive electrode; and a non-aqueous electrolyte.

The negative active material according to one or more embodiments may exhibit high initial efficiency, long cycle-life characteristic, and excellent fast chargeability.

### BRIEF DESCRIPTION OF THE DRAWINGS

The accompanying drawings, together with the specification, illustrate embodiments of the subject matter of the present disclosure, and, together with the description, serve to explain principles of embodiments of the subject matter of the present disclosure.

FIG. 1 to FIG. 4 are schematic diagrams showing a rechargeable lithium battery according to some embodiments.

FIG. 5A is a graph showing the X-ray diffraction analysis results of the negative active material prepared according to Examples 1 to 6, and Comparative Example 1 and FIG. 5B and FIG. 5C are enlarged graphs of portions of FIG. 5A.

FIG. 6A a transmission electron microscope (TEM) image of the negative active material prepared according to Example 2 and FIG. 6B is a set of Fast Fourier Transform (FFT) graphs of the same.

### DETAILED DESCRIPTION

Hereinafter, embodiments of the present disclosure are described in more detail. However, these embodiments are examples, the present disclosure is not limited thereto and the present disclosure is defined by the scope of the appended claims, and equivalents thereof.

As used herein, when a definition is not otherwise provided, it will be understood that when an element such as a layer, film, region, or substrate is referred to as being “on” another element, it may be directly on the other element or intervening elements may also be present.

Unless otherwise specified in the specification, expressions in the singular include expressions in plural. Unless otherwise specified, “A or B” may indicate “includes A, includes B, or includes A and B”.

As used herein, the term “combination thereof” may include a mixture, a laminate, a complex, a copolymer, an alloy, a blend, a reactant of constituents, and/or a reaction product of reactants or constituents.

As used herein, when a definition is not otherwise provided, a particle diameter may be an average particle diameter. Such a particle diameter indicates an average particle diameter (D50) where a cumulative volume is about 50 volume % in a particle size distribution. The average particle diameter (D50) may be measured by any suitable method generally used in the art, for example, by a particle size analyzer, and/or by a transmission electron microscopic (TEM) image, and/or a scanning electron microscopic (SEM) image. In some embodiments, a dynamic light-scattering measurement device is used to perform a data analysis, and the number of particles is counted for each particle size range, and from this, the average particle diameter (D50) value may be easily obtained through a calculation. The average particle size diameter be measured by a laser diffraction method. The laser diffraction may be performed by distributing particles to be measured in a distribution solvent and introducing it to a commercially available laser diffraction particle measuring device (e.g., MT 3000 available from Microtrac, Inc.), irradiating ultrasonic waves of about 28 kHz at a power of about 60 W, and calculating an average particle diameter (D50) in the 50% standard of particle distribution in the measuring device.

In some embodiments, an average particle diameter may be measured by various suitable techniques, and for example, may be measured by a particle analyzer.

In some embodiments, a thickness may be measured by a SEM or a TEM image for the cross-section, but is not limited thereto, and it may be measured by any suitable techniques, as long as it may measure a suitable thickness in the related arts. The thickness may be an average thickness.

As used herein, soft carbon refers to graphitizable carbon materials that are readily graphitized by heat treatment at a high temperature, e.g., about 2800° C., and hard carbon refers to non-graphitizable carbon materials that are substantially not or slightly graphitized by heat treatment. The terms soft carbon and hard carbon may be readily understood by a person having ordinary skill in the related arts upon reviewing this disclosure.

In some embodiments, the crystalline carbon and the amorphous carbon may be distinguished through X-ray diffraction (XRD) measurement. The crystalline carbon includes natural graphite and artificial graphite. Natural graphite may indicate graphite which may be naturally generated by separating it from minerals, and if measured by XRD, the interplanar spacing (d002) of the (002) plane may be about 3.350 Å to about 3.360 Å. Artificial graphite may indicate graphite manufactured by graphitization, and if (e.g., when) measured by XRD, the interplanar spacing (d002) of the (002) plane may be about 3.355 Å to about 3.365 Å. In embodiments, the amorphous carbon may have an interplanar spacing (d002) of the (002) plane of about 3.34 Å or less, if measured by XRD. The XRD may be measured using CuKα ray as a target line with an X-ray diffraction analyzer (e.g., product name: X'Pert, manufacturer: Malvern Panalytical) and by removing a monochromator to improve a peak density resolution. The measurement condition may be 2θ=10° to 80°, a scan speed (°/s) of 0.044 to 0.089, and a step size (°/step) of 0.013 to 0.039.

A negative active material according to one or more embodiments includes a core including a carbonaceous material; and a metal-including nitride on a surface of the core and having lower lithium adsorption energy and lower lithium ion diffusion energy than the core.

In one or more embodiments, the lithium adsorption energy of the metal-including nitride may be about −5.0 eV or more and less than about −1.0 eV, about −4.0 eV or more and less than about −1.0 eV, or about −3.0 eV to about −1.5 eV.

In one or more embodiments, the lithium adsorption energy refers to an adsorption energy to lithium and may be theoretically obtained from a density functional theory (DFT) calculation.

The lithium ion diffusion energy of the metal-including nitride may be about 0 eV to about 0.20 eV, about 0 eV to about 0.10 eV, or about 0 eV to about 0.05 eV.

In one or more embodiments, the lithium adsorption energy of the carbonaceous material core may be about 1.0 eV to about −1.0 eV, about 0 eV to about −1.0 eV, about 0 eV to about −0.5 eV, or about 0 eV to about −0.2 eV. The lithium ion diffusion energy of the carbonaceous material core may be about 0.01 eV to about 1.0 eV, about 0.01 eV to about 0.7 eV, or about 0.05 eV to about 0.5 eV.

The metal-including nitride of which the lithium adsorption energy and the lithium ion diffusion energy are lower than that of the carbonaceous material core, in one or more embodiments, the metal-including nitride of which the lithium adsorption energy is about −5.0 eV or more and less than about −1.0 eV and the lithium ion diffusion energy is about 0 eV to about 0.20 eV, may promote lithium ion intercalation and may absorb and effectively transfer lithium ions on the surface of the carbonaceous material core, thereby serving as a pathway for transporting the lithium ions.

If the metal-including nitride is positioned on the surface of the carbonaceous material core, lithium ion transportation pathway which promotes lithium ion intercalation during charging and discharging, is formed, and thus, lithium ions may be quickly intercalated into the inside of the carbonaceous material.

The metal-including nitride may reduce an interface resistance generated on the surface of the carbonaceous material core. The interface resistance generated in the surface of the carbonaceous material is enlarged, causing the lithium ion intercalation to occur slowly, thereby resulting in formation of lithium metal dendrites. In one or more embodiments, the metal-including nitride reduces the interface resistance, thereby overcoming or reducing the shortcoming related to the formation of lithium metal dendrites. Thus, the deterioration of the fast chargeability and the cycle-life characteristics due to the dendrites may be effectively prevented or reduced. As a result, the negative active material according to one or more embodiments may exhibit improved fast chargeability and cycle-life characteristics.

A metal-including nitride of which the lithium adsorption energy or the lithium ion diffusion energy is higher than that of the carbonaceous material core may be unable to promote the lithium ion intercalation, or may be unable to absorb lithium ions and the lithium ions distribution on the surface may be interrupted, and thus, the lithium ions may be not transferred. If the metal-including nitride includes at least one metal, it is suitable or desirable that the included all metals have lower lithium adsorption energy or lithium ion diffusion energy than that of the carbonaceous material core.

For example, aluminum nitride or silicon nitride having lithium adsorption energy that is out of range may not achieve the desired effects. ScN₂ having the lithium adsorption energy of about −5.0 eV to about −4.0 eV which is lower than graphite being the carbonaceous material (about 0 eV to about −1.0 eV), but the lithium ion diffusion energy of about 0.20 eV to about 0.25 eV which is higher than graphite (about 0.01 eV to about 0.10 eV) and thus, it may be not serve as or include a pathway that transfers lithium ions.

The metal-including nitride may be represented by Chemical Formula 1.

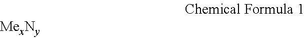

(wherein, Me is Ti, Zr, Hf, Cr, Mo, Nb, Ta, W, V, or a combination thereof, 1≤x≤2, and 1≤y≤3.)

The metal-including nitride is TiN, ZrN, HIN, VN, NbN, TaN, CrN, or a combination thereof.

In one or more embodiments, an amount of the metal-including nitride may be, based on 100 wt % of the negative active material, about 0.5 wt % to about 20 wt %, or about 0.5 wt % to about 10 wt %. If the amount of the metal-including nitride is within the foregoing ranges, more excellent fast charge and discharge characteristics and cycle-life characteristics may be exhibited.

In some embodiments, there is no need to limit a shape in which the metal-including nitride is on the core surface. For example, the metal-including nitrides may be provided in a layer form such that the metal-including nitrides may be continuously present or may be provided in an island form such that the metal-including nitrides may be discontinuously present.

1 The metal-including nitride may be on the surface of the core at a thickness of about 5 nm to about 300 nm, or may be provided at a thickness of about 5 nm to about 200 nm, at a thickness of about 10 nm to about 100 nm, or at a thickness of about 10 nm to about 50 nm. If the metal-including nitride is on the surface of the core at the foregoing thickness ranges, the metal-including nitride may be more uniformly present on the surface of the core.

In one or more embodiments, the carbonaceous material included in the core may be crystalline carbon. The crystalline carbon may be unspecified shaped, sheet-shaped, flake-shaped, sphere-shaped, and/or fiber-shaped natural graphite and/or artificial graphite, or combination thereof.

In one or more embodiments, an amount of the core may be, based on the total 100 wt % of the negative active material, about 80 wt % to about 99.5 wt %, or about 90 wt % to about 99.5 wt %. In one or more embodiments, the core consists of the carbonaceous material and thus, the amount of the core represents an amount of the carbonaceous material.

In one or more embodiments, the carbonaceous material may have a particle diameter, e.g., an average particle diameter D50 of about 3 μm to about 20 μm, or about 5 μm to about 15 μm. Maintaining the carbonaceous material particle diameter within the foregoing ranges may help ensure an advantage or benefit of shortening the pathway that transports the lithium ions inside the carbonaceous material and between themselves. In one or more embodiments, if the core includes the carbonaceous material, which has a particle diameter within the foregoing ranges, the core also may have a particle diameter within the foregoing ranges.

In one or more embodiments, the metal-including nitride may be on the surface of the carbonaceous material, e.g., coated on the surface of the carbonaceous material, which may be confirmed through X-ray Photoelectron Spectroscopy (XPS) analysis. In one or more embodiments, if an XPS analysis is conducted for the negative active material according to one or more embodiments, it may be seen from a peak related to the metal-including nitride. For example, if the peak appears at about 36° to about 37°, about 42° to about 43°, about 61° to about 62°, it may be seen that TiN is present on the surface.

The metal-including nitride on the surface of the carbonaceous material may be detected through a transmission electron microscope (TEM) image, e.g., a Fast Fourier Transform (FFT) result of high-resolution transmission electron microscope (HRTEM). In one or more embodiments, in the FFT result, if an interplanar distance appears about 0.20 nm to about 0.21 nm or about 0.23 nm to about 0.24 nm, the interplanar distance may correspond to TiC(200) and TiC(111), which may confirm that TiN is present on the surface. In one or more embodiments, the metal-including nitride on the surface of the carbonaceous material may be checked by an SEM image and/or an EDS (energy dispersive spectroscopy) result.

The negative active material according to one or more embodiments may be used as a negative electrode active material for a rechargeable lithium battery.

### Method of Preparing Negative Active Material

The negative active material according to one or more embodiments may be prepared by coating crystalline carbon with a metal compound liquid to prepare a primary coating material; primary heat-treating the primary coating material to prepare a primary heat-treated product; preparing a mixture including the primary heat-treated product and a magnesium powder; secondary heat-treating the mixture under a nitrogen atmosphere to prepare a secondary heat-treated product; and etching the secondary heat-treated product. Hereinafter, each procedure will be illustrated in more detail.

Crystalline carbon is coated with a metal compound liquid to prepare a primary coating material.

The metal compound liquid may be prepared by adding a metal compound to a solvent, and the solvent may be methanol, ethanol, propanol, butanol, or a combination thereof, or an anhydrous type (or kind), e.g., anhydrous ethanol.

The metal compound may be metal alkoxide, e.g., metal methoxide, metal ethoxide, metal butoxide, metal propoxide, or a combination thereof.

The metal may be Ti, Zr, Hf, Cr, Mo, Nb, Ta, W, V, or a combination thereof.

The metal compound may be added to the solvent in order to have, based on 100 wt % of the crystalline carbon, about 0.5 wt % to about 20 wt %, about 0.5 wt % to about 10 wt %, or about 2 wt % to about 10 wt %.

The coating may be carried out by adding the crystalline carbon to the metal compound liquid, mixing, and removing the solvent therefrom. The removal of the solvent may be carried out by a drying.

The mixing may be carried out at a speed of about 50 rpm to about 500 rpm, or at a speed of about 100 rpm to about 300 rpm. If the mixing is carried out at the foregoing speeds, the crystalline carbon may be uniformly (e.g., substantially uniformly) distributed in the metal compound liquid.

In the coating, a molten salt may be further added to the crystalline carbon. The molten salt may be NaCl, MgCl₂, NaF, or a combination thereof, and in one or more embodiments, the molten salt may be a mixture of NaCl and MgCl₂ and/or a mixture of NaCl and NaF. In the mixture, a mixing ratio of NaCl, and MgCl₂ or NaF may be about 1:1 to about 8:1 by weight ratio, about 2:1 to about 6:1 by weight ratio, or about 3:1 to about 5:1 by weight ratio.

In the coating, if the molten salt is further added, the metal compound liquid may be more uniformly coated on the carbonaceous material and the metal compound may be converted to a metal oxide at lower temperatures in the subsequent process. In one or more embodiments, using the mixture with the mixing ratio as the molten salt may render to further reduce a molten temperature, thereby converting to metal oxide at substantially lower temperatures.

In one or more embodiments, an amount of the molten salt may be, based on 100 parts by weight of the crystalline carbon, about 50 parts by weight to about 200 parts by weight, about 100 parts by weight to about 200 parts by weight, or about 100 parts by weight to about 150 parts by weight. If the added amount of the molten salt is within the foregoing ranges, the effect of more uniformly coating owing to usage of the molten salt may be more sufficiently obtained.

The primary coating material may be primary heat-treated to prepare a primary heat-treated product. The primary heat-treatment may be carried out by increasing a temperature to about 600° C. to about 1200° C. at an increasing rate of about 0.5° C./minute to about 7° C./minute and maintaining it for about 2 hours to about 8 hours. In one or more embodiments, the increasing rate may be about 1° C./minute to about 7° C./minute, or about 1° C./minute to about 5° C./minute, the increasing temperature may be about 600° C. to about 1000° C. or about 800° C. to about 1000° C., and the maintaining time may be about 2 hours to about 6 hours, or about 2 hours to about 4 hours.

The primary heat-treatment may be carried out under an inert atmosphere and the inert atmosphere may be nitrogen N₂, argon (Ar), or a combination thereof.

The primary heat-treatment may decompose the metal compound and convert the metal compound to metal oxide.

A mixture may be prepared by mixing the primary heat-treated product with a magnesium powder. The magnesium powder may be a catalyst or a reducing agent and the magnesium powder may generate nitride in the secondary heat-treatment.

In one or more embodiments, a mixing ratio of the primary heat-treated product and the magnesium powder may be adjusted in order to have about 1:0.08 to about 1:0.3 by weight ratio, about 1:0.08 to about 1:0.2 by weight ratio, or about 1:0.1 to about 1:0.2 by weight ratio. If the mixing ratio of the primary heat-treated product and the magnesium powder is within the foregoing ranges, the primary heat-treated product and the magnesium powder may be more uniformly distributed and the safety may be further secured or provided in the preparation.

The mixture is secondary heat-treated under a nitrogen atmosphere to prepare a secondary heat-treated product.

The secondary heat-treatment may be performed by increasing the temperature to about 600° C. to about 1200° C. at an increasing rate of about 0.5° C./minute to about 7° C./minute and maintaining at the increased temperature for about 2 hours to about 8 hours. In one or more embodiments, the increasing rate may be about 1° C./minute to about 7° C./minute, or about 1° C./minute to about 5° C./minute, and the maintaining time may be about 2 hours to about 6 hours, or about 2 hours to about 4 hours.

The secondary heat-treatment may convert the primary heat-treated product, e.g., metal oxide into a metal-including nitride.

Thereafter, the secondary heat-treated product was etched to prepare a negative active material.

Before the etching, a cooling to room temperature and a pulverizing may be further carried out.

The etching may be a chemical etching, e.g., a chemical etching using an acid, and in one or embodiments, may include adding the secondary heat-treated product to the acid and mixing. The acid may be hydrochloric acid, nitric acid, sulfuric acid, or a combination thereof. The acid may have a concentration of about 0.1 M to about 5 M, about 0.5 M to about 3 M, or about 1 M to about 3 M.

The mixing may be carried out at a speed of about 100 rpm to about 1000 rpm, about 200 rpm to about 800 rpm, or about 200 rpm to about 600 rpm.

The etching may effectively remove the side products which may be generated in the secondary heat-treatment.

After etching, a separating of the resulting product, e.g., centrifuging and drying may be further carried out.

### Rechargeable Lithium Battery

Another embodiment provides a rechargeable lithium battery including a negative electrode including the negative active material, a positive electrode, and an electrolyte.

### Negative Electrode

The negative electrode includes a current collector and a negative active material layer on the current collector.

The negative active material layer includes the negative active material according to one or more embodiments. In one or more embodiments, the negative active material according to one or more embodiments may be included as a first active material and a silicon-based negative active material may be included as a second active material. A mixing ratio of the first negative active material and the second negative active material may be about 99:1 to about 50:50 by weight ratio, or about 95:5 to about 80:20 by weight ratio.

The silicon-based negative active material may be Si, a Si—C composite, SiOₓ (0<x≤2), Si-Q alloy (wherein Q is an element selected from an alkali metal, an alkaline-earth metal, a Group 13 element, a Group 14 element, a Group 15 element, a Group 16 element, a transition metal, a rare earth element, and a combination thereof, but not Si), and/or the like, or may be at least one thereof mixed with SiO₂. The element Q may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

In one or more embodiments, the Si—C composite may include silicon particles and an amorphous carbon coated on the surface of the silicon particle. For example, the silicon-carbon composite may include secondary particles where silicon primary particles are agglomerated and an amorphous carbon coating layer on the surface of the secondary particles. The amorphous carbon may be between the silicon primary particles, e.g., to coat on the silicon primary particles. The silicon-carbon composite may also include a core in which silicon particles are distributed in an amorphous carbon matrix and an amorphous carbon coating layer coated on a surface of the core.

The secondary particle may be provided at the center of the Si—C composite, so it may be referred to as a core or a center part. The amorphous carbon coating layer may be referred to as an outer part or a shell.

The silicon particle may be nano silicon particles. The nano silicon particle may have a particle diameter of about 10 nm to about 1,000 nm, and according to one or more embodiments, about 20 nm to about 900 nm, about 20 nm to about 800 nm, about 20 nm to about 500 nm, about 20 nm to about 300 nm, or about 20 nm to about 150 nm. If the average particle diameter of the silicon particles is within the foregoing ranges, the extreme volume expansion caused during charge and discharge may be suppressed or reduced, and a breakage of the conductive path due to crushing of the particle may be prevented or reduced.

A mixing ratio of the nano silicon and the amorphous carbon may be about 20:80 to about 70:30 by weight ratio.

In one or more embodiments, the secondary particles or the core may further include crystalline carbon. If the silicon-carbon composite further includes crystalline carbon, the Si—C composite may include secondary particles where the silicon primary particles and crystalline carbon are agglomerated and an amorphous carbon coating layer on the surface of the secondary particles.

If the Si—C includes silicon particles, crystalline carbon, and amorphous carbon, an amount of the amorphous carbon may be about 30 wt % to about 70 wt % based on the total 100 wt % of the Si—C composite and an amount of the crystalline carbon may be about 1 wt % to about 20 wt % based on the total 100 wt % of the Si—C composite. An amount of the silicon particles may be, based on the total 100 wt % of the Si—C composite, about 20 wt % to about 69 wt %, and according to one or more embodiments, about 30 wt % to about 69 wt %.

The particle diameter of the Si—C composite may be suitably or appropriately adjusted, and it is not specifically limited.

If the amorphous carbon is present surrounding the surface of the secondary particles, its thickness may be adjusted suitably or appropriately, but may be provided, for example, at a thickness of about 5 nm to about 100 nm.

The negative active material layer may include a binder and may further include a conductive material (e.g., an electrically conductive material).

For example, the negative active material layer may include the negative active material at about 90 wt % to about 99 wt % and a binder at about 1 wt % to about 10 wt %, and in another embodiments, may include the negative active material at about 90 wt % to about 99 wt %, the binder at about 0.5 wt % to about 5 wt %, and the conductive material at about 0.5 wt % to about 5 wt %.

The binder improves binding properties of negative active material particles with one another and with a current collector. The binder may be a non-aqueous binder, an aqueous binder, a dry binder or combination thereof.

The non-aqueous binder may be polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be a styrene-butadiene rubber, a (meth)acrylated styrene-butadiene rubber, a (meth)acrylonitrile-butadiene rubber, a (meth)acryl rubber, a butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinyl pyridine, chlorosulfonated polyethylene, latex, a polyester resin, a (meth)acrylic resin, a phenol resin, an epoxy resin, polyvinyl alcohol, or a combination thereof.

The aqueous binder may be a cellulose compound, or may be the cellulose compound together with the aqueous binder. The cellulose compound may be referred to as a thickener, because it may impart or increase viscosity, or it may serve a binder and thus, it may refer to as a binder. The cellulose compound may be used in an appropriate or suitable amount within the amount of the binder and it is not limited thereto. The cellulose-based compound includes one or more of carboxymethyl cellulose, hydroxypropylmethyl cellulose, methyl cellulose, or alkali metal salts thereof. The alkali metal may be Na, K, or Li.

The dry binder may be a polymer material that is capable of being fibrous (e.g., capable of being fiberized). For example, the dry binder may be polytetrafluoroethylene, polyvinylidene fluoride, a polyvinylidene fluoride-hexafluoropropylene copolymer, polyethylene oxide, or a combination thereof.

The conductive material is included to provide electrode conductivity (e.g., electrical conductivity). Any suitable electrically conductive material may be used as a conductive material unless it causes a chemical change (e.g., an undesirable chemical change in the rechargeable lithium battery). Examples of the conductive material may be a carbonaceous material such as natural graphite, artificial graphite, carbon black, acetylene black, ketjen black, a carbon fiber, a carbon nanofiber, carbon nanotubes, and/or the like; a metal-based material of a metal powder and/or a metal fiber including copper, nickel, aluminum, silver, and/or the like; a conductive polymer (e.g., an electrically conductive polymer) such as a polyphenylene derivative; or a mixture thereof.

The negative current collector may include a copper foil, a nickel foil, a stainless steel foil, a titanium foil, a nickel foam, a copper foam, a polymer substrate coated with a conductive metal, or a combination thereof.

### Positive Electrode

The positive electrode may include a current collector and a positive electrode active material layer on the current collector. The positive electrode active material layer includes a positive electrode active material and may further include a binder and/or a conductive material (e.g., an electrically conductive material).

For example, the positive electrode may further include an additive that may serve as a sacrificial positive electrode.

An amount of the positive active material may be, about 90 wt % to about 99.5 wt % based on 100 wt % of the positive active material layer, and amounts of the binder and the conductive material may be respectively 0.5 wt % to 5 wt % based on 100 wt % of the positive active material layer.

The positive active material may include a compound (lithiated intercalation compound) that is capable of intercalating and deintercalating lithium. In some embodiments, at least one of a composite oxide of lithium and a metal selected from cobalt, manganese, nickel, or combinations thereof may be used.

The composite oxide may be a lithium transition metal composite oxide, and examples thereof may include lithium nickel-based oxide, lithium cobalt-based oxide, lithium manganese-based oxide, lithium iron phosphate-based compound, cobalt-free nickel-manganese-based oxide, or a combination thereof.

For example, the following compounds represented by any one selected from among the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (O≤f≤2); and LiₐFePO₄ (0.90≤a≤1.8).

In the above chemical formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L¹ is Mn, Al, or a combination thereof.

For example, the positive electrode active material may be may be a high nickel-based positive electrode active material having a nickel amount of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may realize high capacity and may be applied to a high-capacity, high-density rechargeable lithium battery.

The binder improves binding properties of positive electrode active material particles with one another and with a current collector. Examples of the binder may be polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinyl pyrrolidone, polyurethane, polytetrafluoroethylene, polyvinylidene fluoride, polyethylene, polypropylene, a styrene butadiene rubber, a (meth)acrylated styrene butadiene rubber, an epoxy resin, a (meth)acrylic resin, a polyester resin, nylon, and/or the like, but are not limited thereto.

The conductive material is included to provide electrode conductivity (e.g., electrical conductivity), and any suitable electrically conductive material may be used as a conductive material unless it causes a chemical change (e.g., causes an undesirable chemical change in the rechargeable lithium battery). Examples of the conductive material may include a carbonaceous material such as natural graphite, artificial graphite, carbon black, acetylene black, Ketjen black, carbon fiber, carbon nanofiber, carbon nanotube, and/or the like; a metal-based material of a metal powder and/or a metal fiber including copper, nickel, aluminum, silver, and/or the like; a conductive polymer (e.g., an electrically conductive polymer) such as a polyphenylene derivative; or a mixture thereof.

The current collector may include Al, but is not limited thereto.

### Electrolyte

The electrolyte includes a non-aqueous organic solvent and a lithium salt.

The non-aqueous organic solvent serves as a medium that transmits ions taking part in the electrochemical reaction of a battery.

The non-aqueous organic solvent may include a carbonate-based, ester-based, ether-based, ketone-based, alcohol-based, and/or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like.

The ester-based solvent may include methyl acetate, ethyl acetate, n-propyl acetate, dimethyl acetate, methyl propionate, ethyl propionate, decanolide, mevalonolactone, valerolactone, v-butyrolactone, caprolactone, and/or the like.

The ether-based solvent may include dibutyl ether, tetraglyme, diglyme, dimethoxyethane, 2-methyltetrahydrofuran, 2,5-dimethyltetrahydrofuran, tetrahydrofuran, and/or the like. The ketone-based solvent may include cyclohexanone, and/or the like. The alcohol-based solvent may include ethanol, isopropyl alcohol, and/or the like and the aprotic solvent may include nitriles such as R—CN (wherein R is a C2 to C20 linear, branched, or cyclic hydrocarbon group, and may include a double bond, an aromatic ring, and/or an ether bond, and the like); amides such as dimethylformamide; dioxolanes such as 1,3-dioxolane, 1,4-dioxolane, and/or the like; sulfolanes, and/or the like.

The organic solvent may be used alone or in a mixture of two or more.

If the carbonate-based solvent is used, the cyclic carbonate and the linear carbonate may be used together therewith, and the cyclic carbonate and the linear carbonate may be mixed at a volume ratio of about 1:1 to about 1:9.

The electrolyte may further include vinylethylene carbonate, vinylene carbonate, difluoro ethylenecarbonate, chloroethylene carbonate, dichloroethylene carbonate, bromoethylene carbonate, dibromoethylene carbonate, nitroethylene carbonate, cyanoethylene carbonate, fluoroethylene carbonate, or a combination thereof, as an additive.

The lithium salt dissolved in an organic solvent supplies a battery with lithium ions, basically operates the rechargeable lithium battery, and improves transportation of the lithium ions between positive and negative electrodes. Examples of the lithium salt include one or at least two supporting electrolyte salt selected from LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂), where x and y are an integer of 1 to 20, lithium trifluoromethane sulfonate, lithium tetrafluoroethane sulfonate, lithium difluorobis(oxalato)phosphate (LiDFOP), and lithium bis(oxalato) borate (LiBOB).

### Separator

A separator may be between the positive electrode and the negative electrode depending on a type (or kind) of a rechargeable lithium battery. The separator may use polyethylene, polypropylene, polyvinylidene fluoride or multi-layers thereof having two or more layers and may be a mixed multilayer such as a polyethylene/polypropylene double-layered separator, a polyethylene/polypropylene/polyethylene triple-layered separator, a polypropylene/polyethylene/polypropylene triple-layered separator, and/or the like.

The separator may include a porous substrate and a coating layer including an organic material, an inorganic material, or a combination thereof on one or both surfaces (e.g., two opposing surfaces) of the porous substrate.

The porous substrate may be a polymer film formed of any one selected from polyolefin such as polyethylene and polypropylene, polyester such as polyethylene terephthalate and polybutylene terephthalate, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer and/or a (meth)acryl-based polymer.

The inorganic material may be an inorganic particle selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but is not limited thereto.

The organic material and an inorganic material may be mixed in one coating layer, or a coating layer including an organic material and a coating layer including an inorganic material may be stacked.

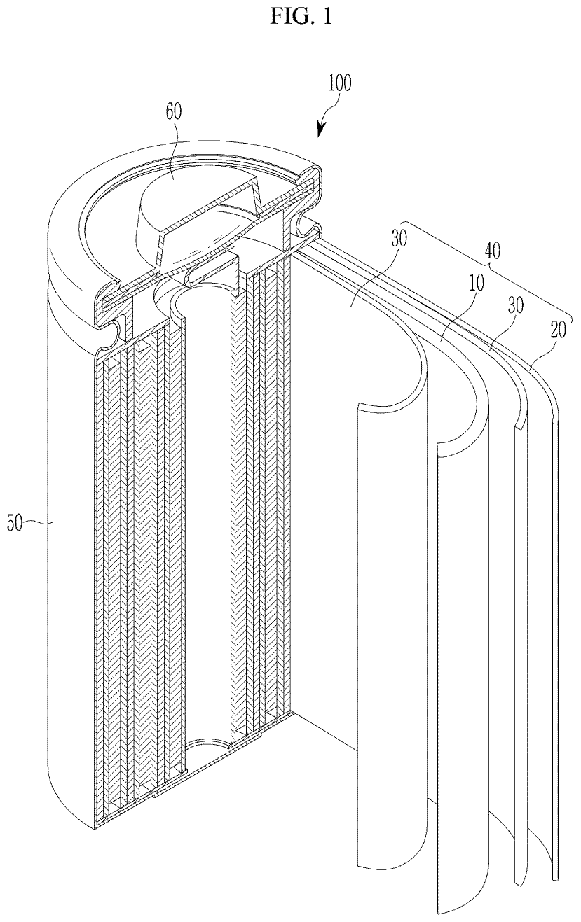

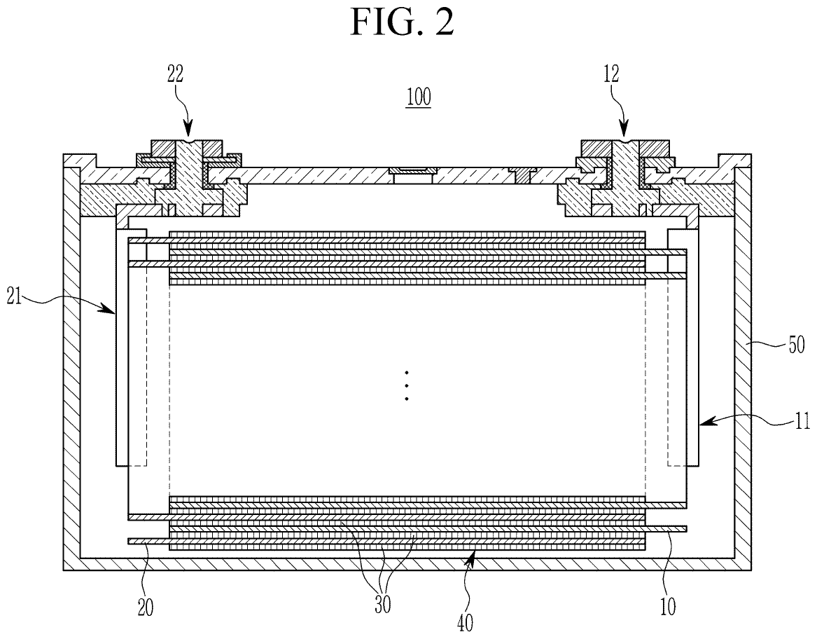

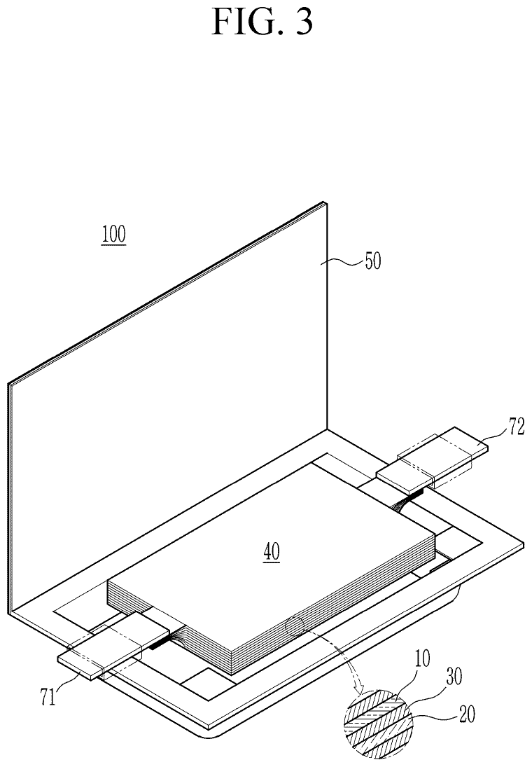

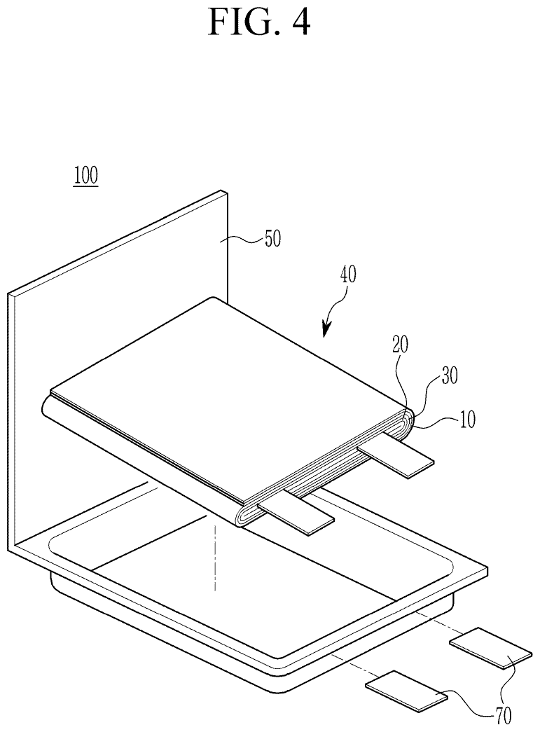

The rechargeable lithium battery may be classified into cylindrical, prismatic, pouch, or coin-type batteries, and/or the like depending on their shape. FIG. 1 to FIG. 4 are schematic views illustrating rechargeable lithium batteries according to embodiments, and FIG. 1 shows a cylindrical battery, FIG. 2 shows a prismatic battery, and FIG. 3 and FIG. 4 show pouch-type batteries. Referring to FIG. 1 to FIG. 4, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte. The rechargeable lithium battery 100 may include a sealing member 60 that seals the case 50, as shown in FIG. 1. In FIG. 2, the rechargeable lithium battery 100 may include a positive electrode lead tab 11 and a positive terminal 12, a negative electrode lead tab 21, and a negative terminal 22. As shown in FIG. 3 and FIG. 4, the rechargeable lithium battery 100 may include an electrode tab 70, which may serve as an electrical path that induces the current formed in the electrode assembly 40 to the outside, for example, a positive electrode tab 71 and a negative electrode tab 72.

The rechargeable lithium battery according to an embodiment may be applied to automobiles, mobile phones, and/or various suitable types (or kinds) of electric devices, as non-limiting examples.

Hereinafter, examples of the present disclosure and comparative examples are described. These examples, however, are not in any sense to be interpreted as limiting the scope of the present disclosure.

### Comparative Example 1

Artificial graphite with an average particle diameter of 12 μm was used as a negative active material.

The negative active material, a styrene-butadiene rubber, and carboxymethyl cellulose were mixed in a water solvent at a weight ratio of 97.5:1:1.5 to prepare a negative active material slurry. The negative active material slurry was coated on a 75 μm-thick copper current collector, dried at 80° C., and roll-pressed. The product was dried at 80° C. for 12 hours to prepare a negative electrode. The prepared negative electrode had a loading level of 6.5 mg/cm², and an active mass density was 1.5 g/cc.

Using the negative electrode, a lithium metal counter electrode, and an electrolyte, a coin-type half-cell was fabricated. As the electrolyte, a 1.15 M LiPF₆ dissolved in ethylene carbonate, ethylmethyl carbonate, and dimethyl carbonate (3:5:2 by volume ratio) was used.

### Example 1

Ti(OC₄H₉)₄ was added to anhydrous ethanol and shaken to prepare a Ti(OC₄H₉)₄ liquid. To the Ti(OC₄H₉)₄ liquid, artificial graphite was added, shaken at 300 rpm, and dried to prepare a primary coating material. An amount of Ti(OC₄H₉)₄ was set to 4 wt % based on 100 wt % of artificial graphite (lithium adsorption energy: −0.09 eV, lithium ion diffusion energy: 0.3 eV).

The primary coating material was subjected to a primary heat-treatment by increasing the temperature at an increasing rate of 5° C./minute to 800° C. under an argon atmosphere, and maintaining at 800° C. for 4 hours in a sintering furnace.

The primary heat-treated product and a magnesium powder were mixed at a weight ratio of 1:10 to prepare a mixture.

The mixture was subjected to a secondary heat-treatment by increasing a temperature at an increasing rate of 5° C./minute to 900° C. under a nitrogen atmosphere, and maintaining it at 900° C. for 6 hours in a sintering furnace.

Chemical etching was carried out by cooling the secondary heat-treated product to a room temperature, pulverizing, adding 100 ml of 2 M HCl to the resulting product, and mixing at 400 rpm.

The resulting etching product was collected by centrifuging and it was dried to prepare a negative active material. The prepared negative active material included an artificial graphite core and TiN (lithium adsorption energy: −2.0 eV, lithium ion diffusion energy: 0.01 eV) provided on the surface of artificial graphite. An amount of TiN was 1 wt % based on 100 wt % of the negative active material and TiN was provided on the surface of the artificial graphite core at a thickness of 10 nm.

A negative electrode and a half-cell were prepared by substantially the same procedure as in Comparative Example 1 except for using the negative active material.

### Example 2

A negative active material was prepared by substantially the same procedure as in Example 1, except that Ti(OC₄H₉)₄ was used at an amount of 8 wt % based on 100 wt % of artificial graphite. The prepared negative active material included an artificial graphite core and TiN (lithium adsorption energy: −2.0 eV, lithium ion diffusion energy: 0.01 eV) provided on the surface of artificial graphite. An amount of TiN was 2 wt % based on 100 wt % of the negative active material and TiN was provided on the surface of the artificial graphite core at a thickness of 50 nm.

A negative electrode and a half-cell were prepared by substantially the same procedure as in Comparative Example 1 except for using the negative active material.

### Example 3

A negative active material was prepared by substantially the same procedure as in Example 1, except that Ti(OC₄H₉)₄ was used at an amount of 20 wt % based on 100 wt % of artificial graphite. The prepared negative active material included an artificial graphite core and TiN (lithium adsorption energy: −2.0 eV, lithium ion diffusion energy: 0.01 eV) provided on the surface of artificial graphite. An amount of TiN was 5 wt % based on 100 wt % of the negative active material and TiN was provided on the surface of the artificial graphite core at a thickness of 100 nm.

A negative electrode and a half-cell were prepared by substantially the same procedure as in Comparative Example 1 except for using the negative active material.

### Example 4

Artificial graphite and a molten salt of a mixture of NaCl and MgCl₂ (mixing ratio of NaCl and MgCl₂: 4:1 by weight ratio) was added to the Ti(OC₄H₉)₄ liquid, and the resultant was primary heat-treated to prepare a primary heat-treated product. The primary heat-treated product and a magnesium powder were mixed to prepare a mixture. Amounts of the primary heat-treated product, the molten salt, and the magnesium powder were set to 12.5:15:1 by weight ratio.

The mixture was secondary heat-treated by substantially the same procedure as in Example 1 to prepare a negative active material. The prepared negative active material included an artificial graphite core and TIN (lithium adsorption energy: −2.0 eV, lithium ion diffusion energy: 0.01 eV) provided on the surface of artificial graphite. An amount of TiN was 1 wt % based on 100 wt % of the negative active material and TiN was provided on the surface of the artificial graphite core at a thickness of 10 nm.

A negative electrode and a half-cell were prepared by substantially the same procedure as in Comparative Example 1 except for using the negative active material.

### Example 5

A negative active material was prepared by substantially the same procedure as in Example 4, except that Ti(OC₄H₉)₄ was used at an amount of 8 wt % based on 100 wt % of artificial graphite. The prepared negative active material included an artificial graphite core and TiN (lithium adsorption energy: −2.0 eV, lithium ion diffusion energy: 0.01 eV) provided on the surface of artificial graphite. An amount of TiN was 2 wt % based on 100 wt % of the negative active material and TiN was provided on the surface of the artificial graphite core at a thickness of 50 nm.

A negative electrode and a half-cell were prepared by substantially the same procedure as in Comparative Example 1 except for using the negative active material.

### Example 6

A negative active material was prepared by substantially the same procedure as in Example 4, except that Ti(OC₄H₉)₄ was used at an amount of 20 wt % based on 100 wt % of artificial graphite. The prepared negative active material included an artificial graphite core and TiN (lithium adsorption energy: −2.0 eV, lithium ion diffusion energy: 0.01 eV) provided on the surface of artificial graphite. An amount of TiN was 5 wt % based on 100 wt % of the negative active material and TiN was provided on the surface of the artificial graphite core at a thickness of 100 nm.

A negative electrode and a half-cell were prepared by substantially the same procedure as in Comparative Example 1 except for using the negative active material.

### Example 7

A negative active material was prepared by substantially the same procedure as in Example 1, except that Ti(OC₄H₉)₄ was used at an amount of 2 wt % based on 100 wt % of artificial graphite. The prepared negative active material included an artificial graphite core and TiN (lithium adsorption energy: −2.0 eV, lithium ion diffusion energy: 0.01 eV) provided on the surface of artificial graphite. An amount of TiN was 0.5 wt % based on 100 wt % of the negative active material and TiN was provided on the surface of the artificial graphite core at a thickness of 5 nm.

A negative electrode and a half-cell were prepared by substantially the same procedure as in Comparative Example 1 except for using the negative active material.

### Example 8

A negative active material was prepared by substantially the same procedure as in Example 1, except that Ti(OC₄H₉)₄ was used at an amount of 80 wt % based on 100 wt % of artificial graphite. The prepared negative active material included an artificial graphite core and TiN (lithium adsorption energy: −2.0 eV, lithium ion diffusion energy: 0.01 eV) provided on the surface of artificial graphite. An amount of TiN was 20 wt % based on 100 wt % of the negative active material and TiN was provided on the surface of the artificial graphite core at a thickness of 300 nm.

A negative electrode and a half-cell were prepared by substantially the same procedure as in Comparative Example 1 except for using the negative active material.

### Example 9

A negative active material was prepared by substantially the same procedure as in Example 1, except the secondary heat-treatment was carried out for 12 hours. The prepared negative active material included an artificial graphite core and TiN (lithium adsorption energy: −2.0 eV, lithium ion diffusion energy: 0.01 eV) provided on the surface of artificial graphite. An amount of TiN was 1 wt % based on 100 wt % of the negative active material and TiN was provided on the surface of the artificial graphite core at a thickness of 20 nm.

A negative electrode and a half-cell were prepared by substantially the same procedure as in Comparative Example 1 except for using the negative active material.

### Comparative Example 2

A negative active material was prepared by substantially the same procedure as in Example 1, except that Al isopropoxide was used instead of Ti(OC₄H₉)₄. The prepared negative active material included an artificial graphite core and AlN (lithium adsorption energy: −1.0 eV, lithium ion diffusion energy: 0.4 eV) provided on the surface of artificial graphite. An amount of AlN was 2 wt % based on 100 wt % of the negative active material and AlN was provided on the surface of the artificial graphite core at a thickness of 50 nm.

A negative electrode and a half-cell were prepared by substantially the same procedure as in Comparative Example 1 except for using the negative active material.

### Comparative Example 3

A negative active material was prepared by substantially the same procedure as in Example 1, except that Si(OCH₃)₄ was used instead of Ti(OC₄H₉)₄. The prepared negative active material included an artificial graphite core and Si₃N₄ (lithium adsorption energy: −1.0 eV, lithium ion diffusion energy: 0.25 eV) provided on the surface of artificial graphite. An amount of Si₃N₄ was 2 wt % based on 100 wt % of the negative active material and Si₃N₄ was provided on the surface of the artificial graphite core at a thickness of 50 nm.

A negative electrode and a half-cell were prepared by substantially the same procedure as in Comparative Example 1 except for using the negative active material.

### Comparative Example 4

A negative active material was prepared by substantially the same procedure as in Example 1, except that a Co₃O₄ liquid prepared by adding Co₃O₄ to HNO₃ and shaking, was used instead of the Ti(OC₄H₉)₄ liquid prepared by adding Ti(OC₄H₉)₄ to anhydrous ethanol. The prepared negative active material included an artificial graphite core and CoN (lithium adsorption energy: −1.0 eV, lithium ion diffusion energy: 0.4 eV) provided on the surface of artificial graphite. An amount of CON was 2 wt % based on 100 wt % of the negative active material and CoN was provided on the surface of the artificial graphite core at a thickness of 50 nm.

A negative electrode and a half-cell were prepared by substantially the same procedure as in Comparative Example 1 except for using the negative active material.

### Comparative Example 5

A negative active material was prepared by substantially the same procedure as in Example 1, except that a mixed liquid of Si(OCH₃)₄ and Ti(OC₄H₉)₄ prepared by adding Si(OCH₃)₄ and Ti(OC₄H₉)₄ to anhydrous ethanol and shaking, was used instead of Ti(OC₄H₉)₄. The prepared negative active material included an artificial graphite core and Si—TiN (lithium adsorption energy of Si: −1.0 eV, lithium ion diffusion energy of Si: 0.25 eV, and lithium adsorption energy of Ti: −2.0 eV, lithium ion diffusion energy of Ti: 0.01 eV) provided on the surface of artificial graphite. An amount of Si—TiN was 2 wt % based on 100 wt % of the negative active material and Si—TiN was provided on the surface of the artificial graphite core at a thickness of 50 nm.

A negative electrode and a half-cell were prepared by substantially the same procedure as in Comparative Example 1 except for using the negative active material.

### Comparative Example 6

A negative active material was prepared by substantially the same procedure as in Example 1, except that iron ethoxide was used instead of Ti(OC₄H₉)₄. The prepared negative active material included an artificial graphite core and Fe₂N (lithium adsorption energy: −1.9 eV and lithium ion diffusion energy: 0.6 eV) provided on the surface of artificial graphite. An amount of Fe₂N was 2 wt % based on 100 wt % of the negative active material and Fe₂N was provided on the surface of the artificial graphite core at a thickness of 50 nm.

A negative electrode and a half-cell were prepared by substantially the same procedure as in Comparative Example 1 except for using the negative active material.

The amount of the artificial graphite, the amount of the nitride, and thickness of nitride according to Examples 1 to 9 and Comparative Examples 1 to 6 are shown in Table 1.

TABLE 1

| | Amount of | | |
|---|---|---|---|
| | artificial | Amount of | Nitride |
| | graphite | nitride | thickness |
| | (wt %) | (wt %) | (nm) |
| Comparative Example 1 | 100 | 0 | 0 |
| Example 1 | 99 | 1 | 10 |
| Example 2 | 98 | 2 | 50 |
| Example 3 | 95 | 5 | 100 |
| Example 4 | 99 | 1 | 10 |
| Example 5 | 98 | 2 | 50 |
| Example 6 | 95 | 5 | 100 |
| Example 7 | 99.5 | 0.5 | 5 |
| Example 8 | 80 | 20 | 300 |
| Example 9 | 99 | 1 | 20 |
| Comparative Example 2 | 98 | 2 | 50 |
| Comparative Example 3 | 98 | 2 | 50 |
| Comparative Example 4 | 98 | 2 | 50 |
| Comparative Example 5 | 98 | 2 | 50 |
| Comparative Example 6 | 98 | 2 | 50 |

### Experimental Example 1) Evaluation of X-ray Diffraction

An X-ray diffraction measurement of the negative active materials of Examples 1 to 9 and Comparative Examples 1 to 6 were performed. The XRD may be measured using CuKα ray as a target line with an X-ray diffraction analyzer (e.g., product name: X'Pert, manufacturer: Malvern Panalytical) and by removing a monochromator to improve a peak density resolution. The measurement condition may be 2θ=10° to 80°, a scan speed (°/s) of 0.06436, and a step size (°/step) of 0.026°/step.

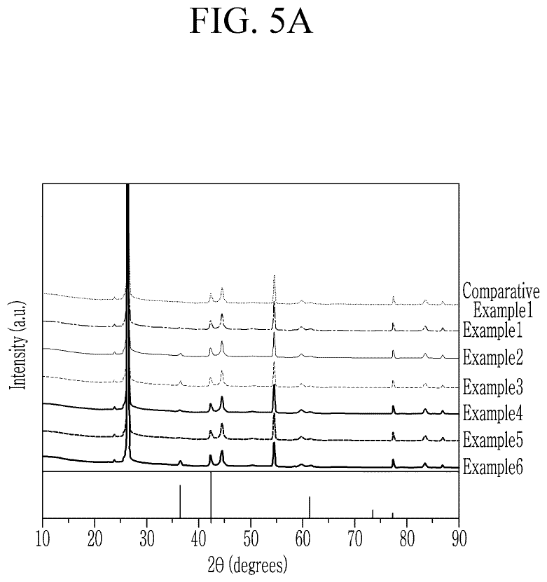

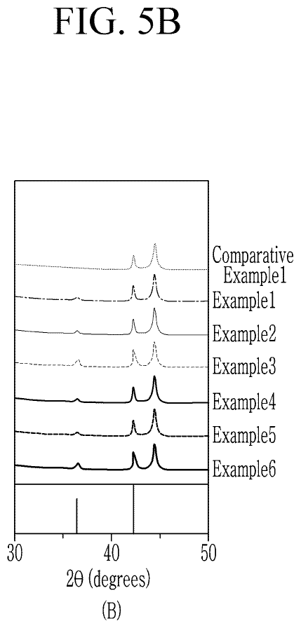

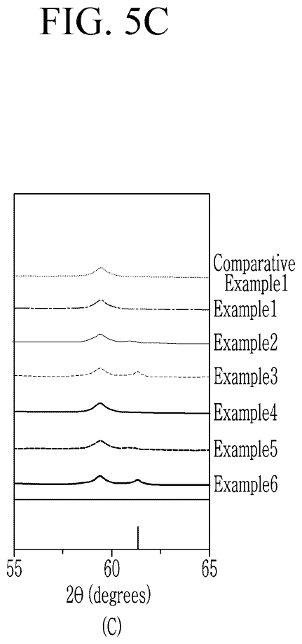

Among results, the results of Examples 1 to 6 and Comparative Example 1 are shown in FIG. 5A. As shown in FIGS. 5B and 5C, unlike to Comparative Example 1 exhibiting only graphite structure, Examples 1 to 6 exhibited peaks corresponding to TiN crystal phase at 36.4°, 42.3°, and 61.4°. From these results, it may be clearly shown that TiN is provided on the surface in Examples 1 to 6.

### Experimental Example 2) TEM and FFT Analysis

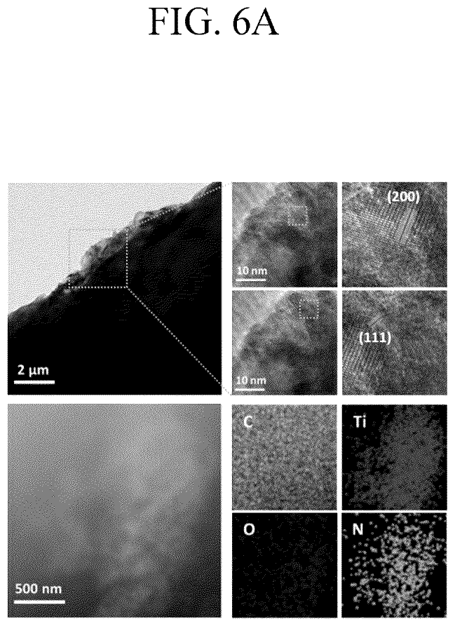

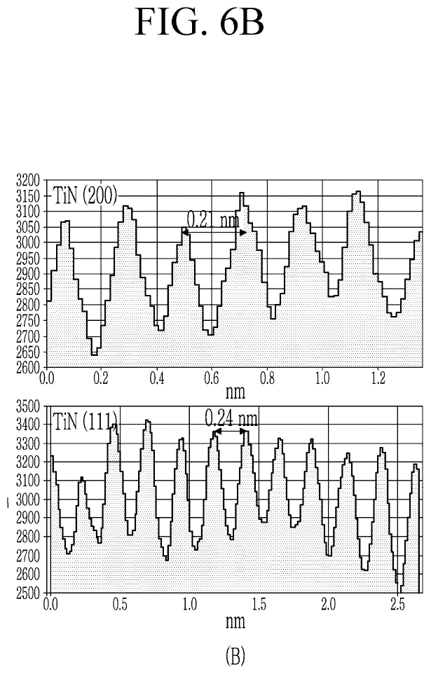

The cross-section of the negative active material prepared by Example 2 was measured by TEM (Transmission electron microscopy) and it was converted by FFT (fast-fourier transform) to measure an interplanar distance. The results are shown in FIGS. 6A and 6B (A: TEM, B: FFT). From the results shown in FIG. 6B, it was confirmed that an interplanar distance 0.21 nm corresponding to TIN (200) and an interplanar distance 0.24 nm corresponding to TIN (111).

### Experimental Example 3) Evaluation of Initial Charge Efficiency

The half-cells according to Examples 1 to 9 and Comparative Examples 1 to 6 were 0.05 C charged and 0.05 C discharged at a voltage range of 0.01 V to 1.5 V vs. Li/Li⁺. The measured charge and discharged capacity, and the initial charge efficiency which is a ratio of charge capacity relative to discharge capacity are shown in Table 2.

Experimental Example 4) Evaluation of fast charge

The half-cells according to Examples 1 to 9 and Comparative Examples 1 to 6 were charged and discharged at a voltage range of 0.01 V to 1.5 V vs. Li/Li⁺ under the following conditions.
0.2 C charge/0.5 C discharge once
1 C charge/0.5 C discharge once
2 C charge/0.5 C discharge once
3 C charge/0.5 C discharge once
4 C charge/0.5 C discharge once
5 C charge/0.5 C discharge once
6 C charge/0.5 C discharge once
2 C charge/0.2 C discharge once

A ratio of charge capacity at 2 C based on charge capacity at 0.2 C was calculated. The results are shown in Table 2, as a fast chargeability (high rate charging rate).

TABLE 2

| | Initial charge | Fast |
|---|---|---|
| | efficiency (%) | chargeability (%) |
| Comparative Example 1 | 94.6 | 47.1 |
| Example 1 | 94.9 | 49.8 |
| Example 2 | 94.7 | 52.8 |
| Example 3 | 94.6 | 48.9 |
| Example 4 | 95.2 | 52.8 |
| Example 5 | 96.1 | 57.4 |
| Example 6 | 94.3 | 53.2 |
| Example 7 | 94.7 | 51.4 |
| Example 8 | 94.1 | 48.1 |
| Example 9 | 94.5 | 47.8 |
| Comparative Example 2 | 93.1 | 46.2 |
| Comparative Example 3 | 92.2 | 42.4 |
| Comparative Example 4 | 93.3 | 47.1 |
| Comparative Example 5 | 93.7 | 46.1 |
| Comparative Example 6 | 93.5 | 46.5 |

As shown in Table 2, Examples 1 to 9 exhibited better initial charge efficiency than Comparative Examples 1 to 6.

The fast chargeability of Examples 1 to 9 exhibited better than Comparative Example 1 without the metal-including nitride. Comparative Examples 2 to 6 including the metal-including nitride having higher lithium adsorption energy or lithium ion diffusion energy than the core, exhibited deteriorated fast chargeability.

### Experimental Example 5) Evaluation of Impedance

The half-cells according to Examples 1 to 9 and Comparative Examples 1 to 6 were, in the voltage range of 0.01 V to 1.5 V vs. Li/Li⁺, conducted at 0.05 C charge/0.05 C discharge once, and then were conducted at 0.05 C under SOC50 (charge refers to as charge to be 50% of charge capacity based 100% of total battery charge capacity and discharge refers to as discharge to be 50% of discharge capacity based 100% of entire battery discharge capacity). Impedance for the charged cell was measured by an EIS (electrochemical impedance spectroscopy) method. The range for measuring the impedance was set to 0.5 MHz to 1 MHz. The results, i.e. electrolyte internal resistance (bulk resistance, R_{b}), resistance by a SEI layer formed on the negative electrode (R_{SEI}), and charge transfer resistance (R_{ct}) are shown in Table 3.

TABLE 3

| | R_{b} (Ω) | R_{SEI} (Ω) | Rct (Ω) |
|---|---|---|---|
| Example 1 | 1.2 | 1.7 | 3.9 |
| Example 2 | 1.5 | 1.8 | 3.8 |
| Example 3 | 1.5 | 1.7 | 3.9 |
| Example 4 | 1.1 | 1.8 | 3.9 |
| Example 5 | 1.2 | 1.7 | 3.6 |
| Example 6 | 1.4 | 1.8 | 3.8 |
| Example 7 | 1.1 | 2.0 | 3.9 |
| Example 8 | 1.4 | 2.0 | 3.9 |
| Example 9 | 1.4 | 2.1 | 4.7 |
| Comparative Example 1 | 1.6 | 3.8 | 11.8 |
| Comparative Example 2 | 1.6 | 3.1 | 8.9 |
| Comparative Example 3 | 1.7 | 4.0 | 13.6 |
| Comparative Example 4 | 1.8 | 3.3 | 10.6 |
| Comparative Example 5 | 1.6 | 3.1 | 5.1 |
| Comparative Example 6 | 1.7 | 3.1 | 8.5 |

As shown in Table 3, the half-cells according to Examples 1 to 9 all exhibited lower R_{b}, R_{SEI} and R_{ct} than Comparative Examples 1 to 6.

While the subject matter of this disclosure has been described in connection with what is presently considered to be practical example embodiments, it is to be understood that the present disclosure is not limited to the disclosed embodiments, but, on the contrary, is intended to cover various modifications and equivalent arrangements included within the spirit and scope of the appended claims, and equivalents thereof.

What is claimed is:

1. A negative active material, comprising:
a core comprising a carbonaceous material; and
a metal-including nitride on a surface of the core and having lower lithium adsorption energy and lower lithium ion diffusion energy than the core.

2. The negative active material as claimed in claim 1, wherein the lithium adsorption energy of the metal-including nitride is about −5.0 eV or more and less than about −1.0 eV.

3. The negative active material as claimed in claim 1, wherein the lithium ion diffusion energy of the metal-including nitride is about 0 eV to about 0.20 eV.

4. The negative active material as claimed in claim 1, wherein the lithium adsorption energy of the carbonaceous material is about 1.0 eV to about −1.0 eV.

5. The negative active material as claimed in claim 1, wherein the lithium ion diffusion energy of the carbonaceous material is about 0.01 eV to about 1.0 eV.

6. The negative active material as claimed in claim 1, wherein the carbonaceous material is crystalline carbon.

7. The negative active material as claimed in claim 6, wherein the crystalline carbon is natural graphite, artificial graphite, or a combination thereof.

8. The negative active material as claimed in claim 1, wherein the metal-including nitride is represented by Chemical Formula 1: 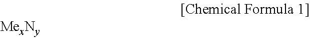
wherein, Me is Ti, Zr, Hf, Cr, Mo, Nb, Ta, W, V, or a combination thereof, 1≤x≤2 and 1≤y≤3.

9. The negative active material as claimed in claim 1, wherein the metal-including nitride is TIN, ZrN, HIN, VN, NbN, TaN, CrN, or a combination thereof.

10. The negative active material as claimed in claim 1, wherein an amount of the metal-including nitride is about 0.5 wt % to about 20 wt % based on 100 wt % of the negative active material.

11. The negative active material as claimed in claim 1, wherein the metal-including nitride is on the surface of the core at a thickness of about 5 nm to about 300 nm.

12. The negative active material as claimed in claim 1, wherein an amount of the core is about 80 wt % to about 99.5 wt % based on 100 wt % of the negative active material.

13. A method of preparing a negative active material, the method comprising:
coating crystalline carbon with a metal compound liquid to prepare a primary coating material;
primary heat-treating the primary coating material to prepare a primary heat-treated product;
preparing a mixture comprising the primary heat-treated product and magnesium powder;
secondary heat-treating the mixture under a nitrogen atmosphere to prepare a secondary heat-treated product; and
etching the secondary heat-treated product.

14. The method of preparing the negative active material as claimed in claim 13, further comprising:
adding a molten salt to the crystalline carbon.

15. The method of preparing the negative active material as claimed in claim 14, wherein the molten salt is NaCl, MgCl₂, NaF, or a combination thereof.

16. The method of preparing the negative active material as claimed in claim 14, wherein an added amount of the molten salt is about 50 parts by weight to about 200 parts by weight based on 100 parts by weight of the crystalline carbon.

17. The method of preparing the negative active material as claimed in claim 13, wherein the metal compound is metal alkoxide.

18. The method of preparing the negative active material as claimed in claim 13, wherein a mixing ratio of the heat-treated product and the magnesium powder is about 1:0.08 to about 1:0.3 by weight ratio.

19. The method of preparing the negative active material as claimed in claim 13, wherein the etching is carried out by a chemical etching.

20. A rechargeable lithium battery, comprising:
a negative electrode comprising the negative active material as claimed in claim 1;
a positive electrode; and
an electrolyte.
